(19) United States
(12) Patent Application Publication
(10) Pub. No.: US 2016/0231744 A1
(43) Pub. Date: Aug. 11, 2016

(54) MOBILE BODY

(71) Applicant: MURATA MACHINERY, LTD., Kyoto-shi (JP)

(72) Inventors: Hideki KANAME, Kyoto (JP); Tsuyoshi Nakano, Kyoto (JP)

(21) Appl. No.: 14/887,524

(22) Filed: Oct. 20, 2015

(30) Foreign Application Priority Data
Oct. 30, 2014 (JP) 2014-221200

(51) Int. Cl. G05D 1/00

(52) U.S. Cl. CPC G05D 1/0088

(57) ABSTRACT

A mobile body includes an obstacle information obtaining unit, a storage unit, a self-position estimating unit, and a map creating unit. The obstacle information obtaining unit obtains position information about an obstacle. The storage unit stores environmental map restore data and an environmental map created at a previous time. The self-position estimating unit estimates an estimated position based on a comparison between the environmental map created at a previous time and the position information about the obstacle obtained by the obstacle information obtaining unit. The map creating unit creates an enlarged environmental map, and deletes, out of regions included in the enlarged environmental map, a region corresponding to a non-information region from the enlarged environmental map, so as to create an environmental map on an estimated position.

### CROSS-REFERENCE TO RELATED APPLICATIONS

This application claims priority under 35 U.S.C. 119 to Japanese Patent Application No. 2014-221200, filed on Oct. 30, 2014, which application is hereby incorporated by reference in its entirety.

### BACKGROUND OF THE INVENTION

1. Field of the Invention

The present invention relates to a mobile body that travels in a moving region while estimating a position in the moving region.

2. Description of the Related Art

Conventionally, a mobile body that autonomously moves in an ambient environment is known. When the mobile body autonomously moves in an ambient environment, an environmental map illustrating regions in a moving space where an object (hereinafter, an obstacle) is present and is not present is necessary. As a method for obtaining such an environmental map, various methods have been invented, but in recent years, attention has been paid to SLAM (Simultaneous Localization and Mapping) as a technique for estimating positions and creating an environmental map at a real time during a movement. A moving robot for creating an environmental map using topographic data obtained as a result of distance measurement using a Laser Range Finder (LRF) or a camera according to the SLAM has been proposed.

In the method for creating the environmental map according to the SLAM, when a circular environmental map is created, a start portion and an end portion occasionally do not match with each other (a so-called annular route problem) because measurement errors are accumulated.

Japanese Unexamined Patent Publication No. 2010-92147 proposes that an environmental map is divided into a plurality of partial maps so that the annular route problem does not arise.

In a mobile body described in Japanese Unexamined Patent Publication No. 2010-92147, when the plurality of partial maps constituting the environmental map are created, a plurality of connecting points is set, and connecting points on partial maps to be connected are selected from the set connecting points so that a connecting relationship is set. In this case, it is difficult to plan creation of the partial maps considering how the environment map is divided, and thus automation of the creation of the map is difficult.

Further, particularly when a laser range finder or a camera in which measurable distance is large is used and a region where a mobile body moves is equivalent or narrower than a region whose distance can be measured by the laser range finder or the camera, the annular route problem arises on the partial maps even when the environmental map is divided into the plurality of partial maps.

### SUMMARY OF THE INVENTION

Preferred embodiments of the present invention solve the annular route problem of an environmental map in a mobile body that travels in a moving region during estimation of a position of the mobile body in the moving region using the environmental map.

A plurality of aspects of various preferred embodiments of the present invention are described below. These aspects can be arbitrarily combined as needed or desired.

A mobile body according to one aspect of various preferred embodiments of the present invention is a mobile body that travels in a moving region during estimation of a position in the moving region. The mobile body includes an obstacle information obtaining unit, a storage unit, a self-position estimating unit, and a map creating unit.

The obstacle information obtaining unit obtains position information about an obstacle present around the mobile body. The storage unit stores environmental map restore data and an environmental map created at a previous time. The environmental map restore data is the position information about the obstacle obtained by the obstacle information obtaining unit on a predetermined position of the moving region in advance.

The self-position estimating unit estimates an estimated position based on comparison between the environmental map created at a previous time and the position information about the obstacle obtained by the obstacle information obtaining unit. The estimated position is a current position of the mobile body.

The map creating unit creates an enlarged environmental map using the environmental map restore data and/or the position information about the obstacle obtained on the estimated position and the environmental map created at the previous time.

After the enlarged environmental map is created, the map creating unit deletes, out of regions included in the enlarged environmental map, a region corresponding to a non-information region from the enlarged environmental map, so as to create an environmental map on the estimated position.

The non-information region is a region where the position information about the obstacle cannot be obtained by the obstacle information obtaining unit.

While the above-described mobile body is moving in a predetermined moving region, the obstacle information obtaining unit obtains position information about an obstacle present around the mobile body. After the position information about the obstacle is obtained, the self-position estimating unit estimates a current position of the mobile body as the estimated position based on the comparison between the environmental map created at the previous time and the position information about the obstacle obtained by the obstacle information obtaining unit.

After the estimated position is estimated, the map creating unit creates the enlarged environmental map using the environmental map restore data and/or the position information about the obstacle obtained on the estimated position, and the environmental map created at the previous time. After the enlarged environmental map is created, the map creating unit deletes, out of the regions included in the enlarged environmental map, the region corresponding to the non-information region from the enlarged environmental map, so as to create an environmental map on the estimated position and store the created environmental map in the storage unit.

In the above-described mobile body, out of the regions included in the enlarged environmental map, a region corresponding to a region where the position information about the obstacle cannot be obtained by the obstacle information obtaining unit (the non-information region) is deleted from the enlarged environmental map, and an environmental map on the estimated position (the current position) is created. As a result, the annular route problem on the created environmental map is reduced or eliminated.

The map creating unit may delete, out of the regions included in the enlarged environmental map, a region corresponding to a transit region as the non-information region from the enlarged environmental map. The transit region is a region where the mobile body has passed until a predetermined timing. As a result, a region where the mobile body has already passed and the obstacle information obtaining unit cannot obtain the position information about the obstacle is able to be excluded from the environmental map.

The map creating unit may delete, out of the regions included in the enlarged environmental map, a region corresponding to a measurement range outer region as the non-information region from the enlarged environmental map. The measurement range outer region is a region spaced away from the estimated position by a maximum obtainable distance or more. The maximum obtainable distance is a measurement distance in which the obstacle information obtaining unit is able to obtain the position information about the obstacle.

As a result, a region where the position information about the obstacle cannot be obtained because it is a position separated by a maximum measurable distance or more of the obstacle information obtaining unit is able to be excluded from the environmental map. As a result, the annular route problem is prevented from occurring in the environmental map.

The map creating unit may delete, out of the regions included in the enlarged environmental map, the region corresponding to a non-detection region as the non-information region from the enlarged environmental map. The non-detection region is a region that is spaced away from the estimated position by a distance up to the position information about the obstacle actually obtained by the obstacle information obtaining unit or more.

As a result, a region where the obstacle information obtaining unit cannot obtain the position information about the obstacle in a thickness direction of the obstacle is able to be excluded from the environmental map.

The map creating unit may divide the enlarged environmental map into a predetermined number of partial regions, and may delete a partial region to be deleted out of the partial regions as the non-information region from the enlarged environmental map. The partial region to be deleted is a partial region in which a state where less than a first number of pieces of the position information about the obstacle are included continues for a first time or more. As a result, a region that is able to be deleted from the enlarged environmental map is suitably selected so as to be capable of being deleted from the enlarged environmental map.

When a second number or more of the partial regions to be deleted are continuously arranged in columns or in rows, the map creating unit may delete a region defined by the continuously arranged second number or more of the partial regions to be deleted as the non-information region from the enlarged environmental map. As a result, the partial regions to be deleted are able to be deleted from the enlarged environmental map efficiently.

The second number may be the same as a number of divisions in columns and/or a number of divisions in rows. The number of divisions in columns is a number of divisions of the enlarged environmental map in columns. The number of divisions in rows is a number of divisions of the enlarged environmental map in rows. As a result, the partial regions to be deleted are able to be deleted from the enlarged environmental map more efficiently.

The map creating unit may create the enlarged environmental map using the environmental map restore data corresponding to a future position. At this time, the map creating unit counts the position information about the obstacle included in the partial regions that includes the position information about the obstacle in the environmental map restore data corresponding to the future position as well as the position information about the obstacle on a current estimated position. The future position is a position to which the mobile body plans to arrive by moving from the estimated position.

When the enlarged environmental map is created so as to include the environmental map restore data corresponding to the future position, the restoration of the environmental map is able to be sped up.

Further, the position information about the obstacle included in the partial regions that includes the position information about the obstacle included in the environmental map restore data corresponding to the future position as well as the position information about the obstacle obtained on the current estimated position is counted. As a result, the position information about the obstacle included in the environmental map restore data corresponding to the future position is prevented from being deleted from the environmental map by mistake.

In the mobile body that travels in the moving region during the estimation of the position of the mobile body in the moving region using the environmental map, the annular route problem on the environmental map that arises when the environmental map is divided is solved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram illustrating a configuration of a mobile body according to a first preferred embodiment of the present invention.

FIG. 2 is a flowchart illustrating a method for creating an environmental map

FIG. 3 is a diagram illustrating one example of a moving region and a traveling route.

FIG. 4 is a diagram illustrating a relationship between the moving region and a measurement range of a laser range sensor.

FIG. 5A is a diagram illustrating one example of the environmental map stored in a storage unit.

FIG. 5B is a diagram illustrating one example of position information about an obstacle obtained on a position P3.

FIG. 5C is a diagram illustrating one example of environmental map restore data corresponding to a future position.

FIG. 6A is a diagram illustrating one example of a first enlarged environmental map to be created when an instruction traveling mode is executed.

FIG. 6B is a diagram illustrating one example of the first enlarged environmental map to be created when a reproduction traveling mode is executed.

FIG. 7 is a diagram schematically illustrating one example where a second enlarged environmental map is divided.

FIG. 8A is a diagram illustrating one example of a state in which position information about an obstacle obtained on a current estimated position and the environmental map restore data corresponding to the future position are plotted on the second enlarged environmental map.

FIG. 8B is a diagram illustrating another example of a state in which the position information about the obstacle obtained on the current estimated position and the environmental map restore data corresponding to the future position are plotted on the second enlarged environmental map.

FIG. 9A is a diagram illustrating one example of partial regions to be deleted when the position information about the obstacle is counted during execution of the instruction traveling mode.

FIG. 9B is a diagram illustrating one example of the partial regions to be deleted when the position information about the obstacle is counted during execution of the reproduction traveling mode.

FIG. 10A is a diagram illustrating one example of the environmental map to be created on the current position during the execution of the instruction traveling mode.

FIG. 10B is a diagram illustrating one example of the environmental map to be created on the current position during the execution of the reproduction traveling mode.

FIG. 11 is a flowchart illustrating an outline of an operation of the mobile body.

FIG. 12 is a flowchart illustrating an operation of the mobile body during the execution of the reproduction traveling mode.

FIG. 13 is a flowchart illustrating an operation of the mobile body during the execution of the instruction traveling mode.

### DETAILED DESCRIPTION OF THE PREFERRED EMBODIMENTS

### First Preferred Embodiment

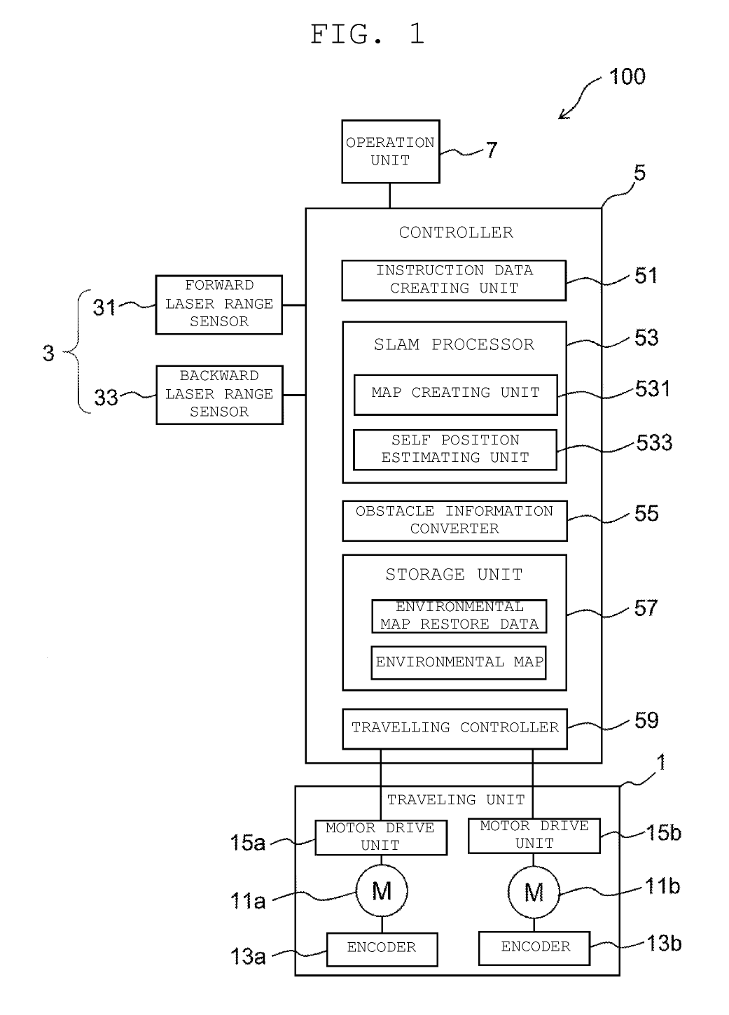

An entire configuration of a mobile body 100 according to a first preferred embodiment of the present invention is described below with reference to FIG. 1.

The mobile body 100 preferably includes a traveling unit 1, an obstacle information obtaining unit 3, and a controller 5. The traveling unit 1 is provided to a main body of the mobile body 100, and moves the mobile body 100 in a predetermined moving region.

The obstacle information obtaining unit 3 includes a forward laser range sensor 31 provided to a front side of the mobile body 100 in a traveling direction, and a backward laser range sensor 33 provided to a rear side of the mobile body 100 in the traveling direction. The sensors 31 and 33 detect obstacles on front and rear sides of the mobile body 100.

The forward laser range sensor 31 and the backward laser range sensor 33 are Laser Range Finders (LRF) that emit laser beams pulse-oscillated by laser oscillators to target objects such as obstacles, respectively, and receive reflected light reflected from the target objects through laser receivers, so as to calculate distances up to the target objects. The forward laser range sensor 31 and the backward laser range sensor 33 as the laser range finders scan laser beams to be emitted in a fan-shaped fashion at predetermined angles using rotation mirrors.

In this preferred embodiment, a distance measurable range (one example of a maximum obtainable distance) where the position information about the obstacle (described later) can be obtained by the forward laser range sensor 31 is wider than a distance measurable range of the backward laser range sensor 33. For example, in this preferred embodiment, the backward laser range sensor 33 is able to detect an object in a range of about 180° on the rear side of the mobile body 100 within an about 5-meter radius from the backward laser range sensor 33.

On the other hand, the forward laser range sensor 31 can detect an object in a range of about 180° on the front side of the mobile body 100 within an about 20-meter radius from the forward laser range sensor 31.

Since the obstacle information obtaining unit 3 includes the forward laser range sensor 31 and the backward laser range sensor 33, the obstacle information obtaining unit 3 is able to detect obstacles present in a wider range from the mobile body 100 (particularly, on the front side of the mobile body 100). The distance measurable ranges of the forward laser range sensor 31 and the backward laser range sensor 33 are not limited to the above detection ranges, and thus suitable detection ranges can be set if necessary.

Further, in this preferred embodiment, the forward laser range sensor 31 and/or the backward laser range sensor 33 are/is attached to a front side and/or a rear side above the main body of the mobile body 100 in a vertical direction (for example, a position higher than someone's height). For example, when an object placed on a floor surface as the moving region frequently moves (for example, when a layout of shelves and a signboard is frequently changed in a retailer), an influence of a temporal change in the position information about the obstacle obtained by the forward laser range sensor 31 and the backward laser range sensor 33 (particularly, a change such that an object present at a certain time is not present at another time) to self-position estimation and autonomous traveling of the mobile body 100 is reduced.

The controller 5 is a computer that includes a CPU (Central Processing Unit), a storage device (i.e., a storage device such as a RAM (Random Access Memory), a ROM (Read Only Memory), an HDD (Hard Disk Drive) or an SSD (Solid State Drive)), and various interfaces. Some of or all of functions of components of the controller 5, described later, may be realized by executing predetermined programs stored in the storage device.

Alternatively, some of or all of the functions of the components of the controller 5 may be realized by hardware such as a custom IC.

The controller 5 controls the traveling unit 1 based on an operation through an operation unit 7, described later, while estimating a position of the mobile body 100 in the moving region based on a signal input from the obstacle information obtaining unit 3 at the time of executing an instruction traveling mode to instruct a traveling route.

On the other hand, at the time of executing a reproduction traveling mode for autonomously traveling on a predetermined traveling route, the controller 5 estimates a position of the mobile body 100 in the moving region based on the position information about the obstacle input from the obstacle information obtaining unit 3, and controls the traveling unit 1 based on a comparison between the estimated position of the mobile body 100 and position information shown in a traveling schedule.

The mobile body 100 further includes the operation unit 7 as well as the traveling unit 1, the obstacle information obtaining unit 3, and the controller 5. The operation unit 7 accepts an instruction input through an operator's manual operation. The operation unit 7 preferably is be provided with, for example, right and left throttle grips that independently accept the instruction input of control according to a rotation angle about a shaft. Further, the operation unit 7 may be a combination of a throttle grip that accepts an advancing speed input, and a steering wheel that accepts an instruction of a steering direction, for example. Further, the operation unit 7 may be a combination of a throttle lever and another input unit, for example.

A detailed configuration of the traveling unit 1 is described below with reference to FIG. 1. The traveling unit 1 includes a pair of motors 11a and 11b, encoders 13a and 13b, and motor drive units 15a and 15b correspondingly to two traveling wheels (not illustrated).

The pair of motors 11a and 11b is connected to output rotary shafts so that the traveling wheels are rotatable, and the rotation of the output rotary shafts of the motors 11a and 11b rotates the traveling wheels.

The encoders 13a and 13b are connected to the output rotary shaft of the motor 11a and the output rotary shaft of the motor 11b, respectively, and detect rotating positions of the motors 11a and 11b.

The motor drive units 15a and 15b feedback-control the corresponding motors 11a and 11b, respectively, based on a control amount input from a traveling controller 59 (described later), and the rotating positions of the motors 11a and 11b detected by the corresponding encoders 13a and 13b.

The detailed configuration of the controller 5 is described below with reference to FIG. 1. The controller 5 is configured or programmed to include an instruction data creating unit 51, an SLAM processor 53, an obstacle information converter 55, a storage unit 57, and the traveling controller 59.

The instruction data creating unit 51 creates a traveling schedule that is an aggregate of passage times and passage point data corresponding to the passage times in the instruction traveling mode.

The SLAM processor 53 executes an SLAM process to simultaneously estimate a position and creating an environmental map. The detailed configuration of the SLAM processor 53 is described later.

The obstacle information converter 55 converts detection signals obtained in the obstacle information obtaining unit 3 (the forward laser range sensor 31 and the backward laser range sensor 33) into the position information about the obstacle present around the mobile body 100. For example, the obstacle information converter 55 converts the detection signals obtained in the obstacle information obtaining unit 3 into the position information about the obstacle that is a coordinate value on a predetermined coordinate.

The storage unit 57 is a storage region that is provided in at least a portion of a storage region of the storage device in the controller 5. The storage unit 57 stores environmental map restore data and environmental map therein. The environmental map restore data is the position information about the obstacle obtained on a predetermined position in the moving region where the mobile body 100 moves by the obstacle information obtaining unit 3 in advance.

The environmental map is an environmental map that is created by a map creating unit 531 at the time of previously estimating the position, and the storage unit 57 stores the environmental map created at the previous time.

The storage unit 57 further stores a traveling schedule representing a traveling route where the mobile body 100 autonomously moves at the time of executing the reproduction traveling mode. At the time of executing the reproduction traveling mode, the mobile body 100 refers to a target position shown in the traveling schedule and controls the traveling unit 1 so as to arrive at the target position.

The traveling controller 59 generates control amounts of the motors 11a and 11b and outputs the control amounts to the motors 11a and 11b of the traveling unit 1 based on a traveling command to be input.

The traveling command to be input into the traveling controller 59 is an instruction input to be input from the operator through the operation unit 7 in the instruction traveling mode. On the other hand, the traveling command to be input into the traveling controller 59 is created based on comparison between the position on the environmental map estimated by the SLAM processor 53 and the traveling schedule in the reproduction traveling mode.

As the traveling controller 59, for example, a motion controller can be used, for example.

A detailed configuration of the SLAM processor 53 is described below with reference to FIG. 1. As illustrated in FIG. 1, the SLAM processor 53 is configured or programmed to include the map creating unit 531 and a self-position estimating unit 533.

The map creating unit 531 creates a local map and a global map (the environmental map) based on the position information about the obstacle obtained by the obstacle information obtaining unit 3. In this preferred embodiment, the map creating unit 531 uses the position information about the obstacle obtained by the obstacle information obtaining unit 3 as the local map.

On the other hand, the environmental map is created by using the position information about the obstacle obtained by the obstacle information obtaining unit 3 and/or the environmental map restore data stored in the storage unit 57, and the environmental map that is crated at the previous time and is stored in the storage unit 57. A method for creating the environmental map in the map creating unit 531 is described in detail later.

The self-position estimating unit 533 corrects the position of the mobile body 100 to be estimated from a moving amount from the traveling unit 1 (in this preferred embodiment, to be calculated based on rotation numbers of the traveling wheels obtained from the encoders 13a and 13b) based on a result of the comparison (a map matching) between the environmental map that is created at the previous time and is stored in the storage unit 57 and the local map (the position information about the obstacle) obtained on the current position, so as to estimate the position of the mobile body 100.

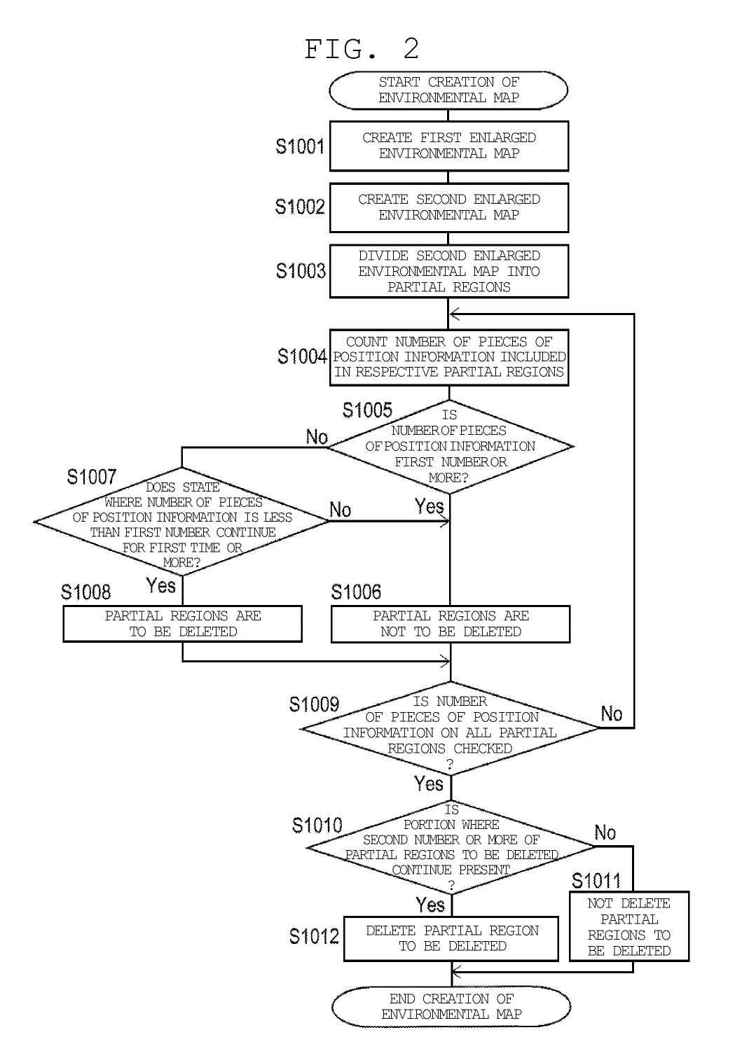

The operation of the mobile body 100 is described below. A non-limiting example of a method for creating an environmental map in the map creating unit 531 is described first with reference to FIG. 2.

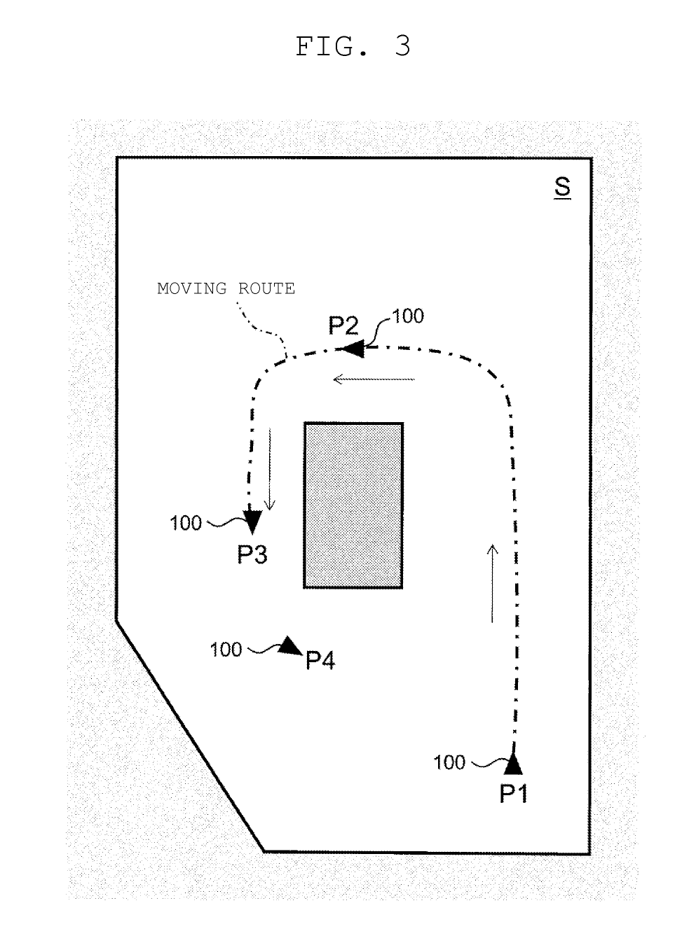

The following describes a case where when the mobile body 100 starts to move from a position P1 and arrives at a position P3 via a position P2 along a moving route indicated by an alternate long and short dash line in FIG. 3 in a moving region S illustrated in FIG. 3, the map creating unit 531 creates an environmental map on the position P3 as an example. FIG. 3 is a diagram illustrating one example of the moving region and the traveling route.

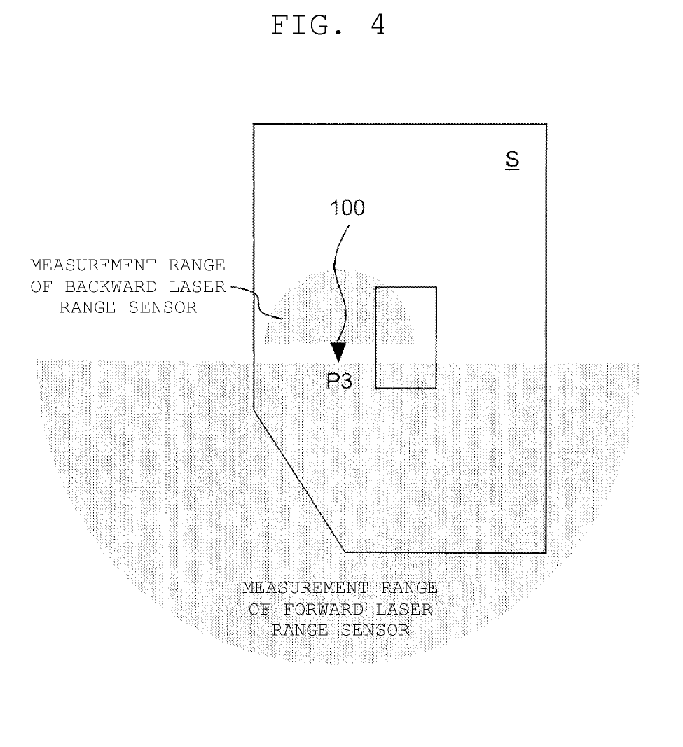

Further, a measurement range of the forward laser range sensor 31, and a measurement range of the backward laser range sensor 33 on the position P3 in the moving region S are as illustrated in FIG. 4. FIG. 4 is a diagram illustrating a relationship between the moving region and measurement ranges of the laser range sensors.

An obstacle (a wall or the like) above the moving region S (viewed in FIG. 4) is out of the measurement range of the backward laser range sensor 33 on the position P3 as illustrated in FIG. 4.

When the environmental map is started to be created, the map creating unit 531 first creates a first enlarged environmental map (step S1001). Specifically, the map creating unit 531 creates a temporary first enlarged environmental map using the environmental map that is created at the previous time and is stored in the storage unit 57, the environmental map restore data corresponding to the position P3 or the position information about the obstacle (the local map) obtained on the position P3, and the environmental map restore data corresponding to a future position P4 at the time of executing the reproduction traveling mode.

More specifically, the map creating unit 531 disposes the above three maps on a position on the first enlarged environmental map corresponding to the position P3 so as to create the first enlarged environmental map. The use of the environmental map restore data corresponding to the future position P4 at the time of creating the first enlarged environmental map can speed up restoration of the environmental map at the time of executing the reproduction traveling mode.

On the other hand, when the instruction traveling mode is executed in the mobile body 100, the map creating unit 531 disposes the position information about the obstacle (the local map) obtained on the position P3 and the environmental map that is created at the previous time and is stored in the storage unit 57 on a position on the first enlarged environmental map corresponding to the position P3 so as to create the first enlarged environmental map.

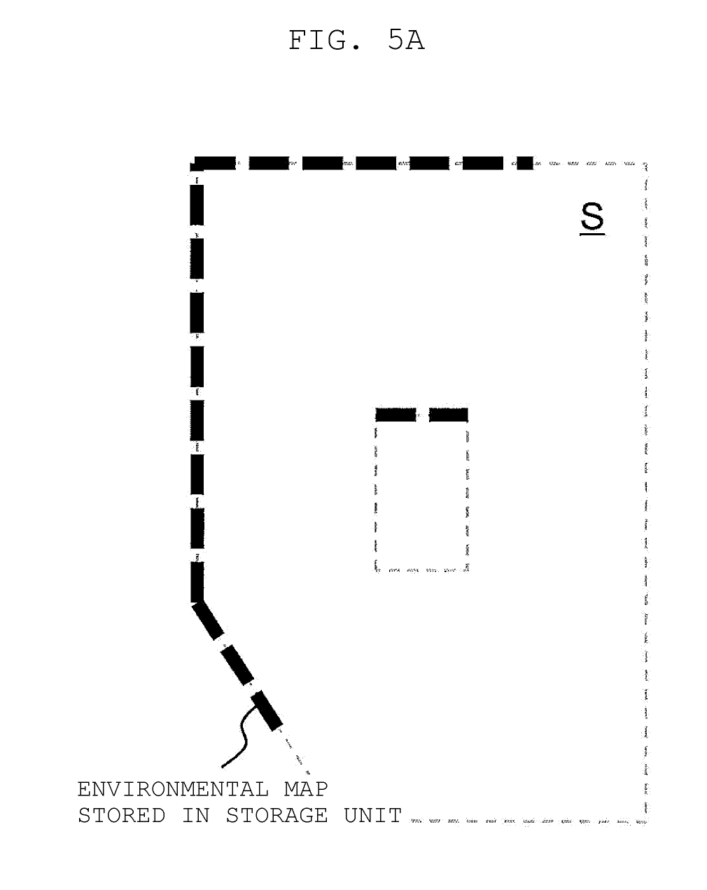

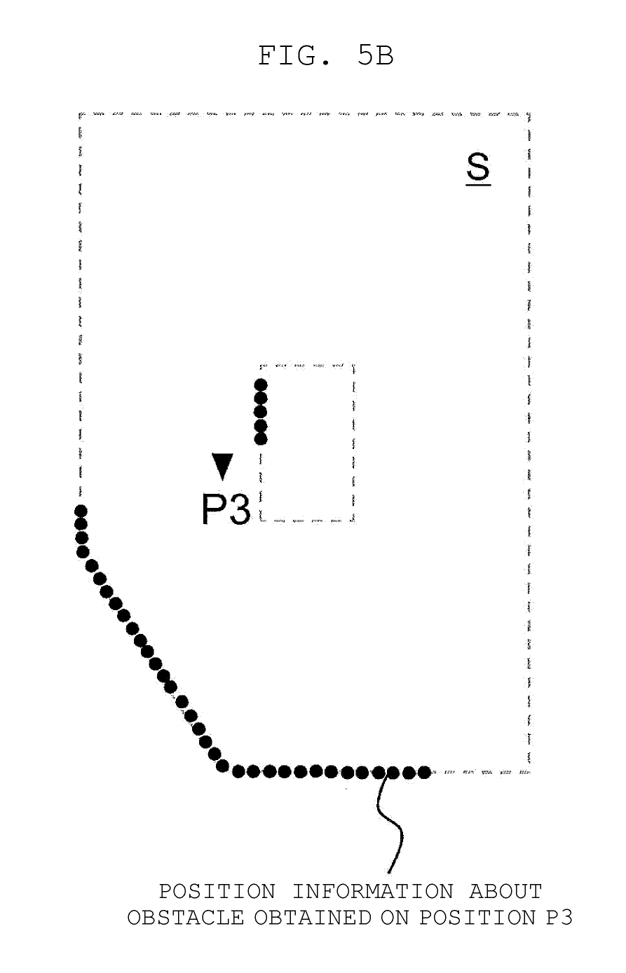

For example, the environmental map created at the previous time is created on the position P2 as indicated by a thick dotted line in FIG. 5A, the position information about the obstacle on the position P3 is obtained as indicated by a black circle in FIG. 5B, and the environmental map restore data corresponding to the future position P4 is data indicated by a white circle in FIG. 5C. FIG. 5A is a diagram illustrating one example of the environmental map stored in the storage unit. FIG. 5B is a diagram illustrating one example of the position information about the obstacle (the local map) obtained on the position P3. FIG. 5C is a diagram illustrating one example of the environmental map restore data corresponding to the future position.

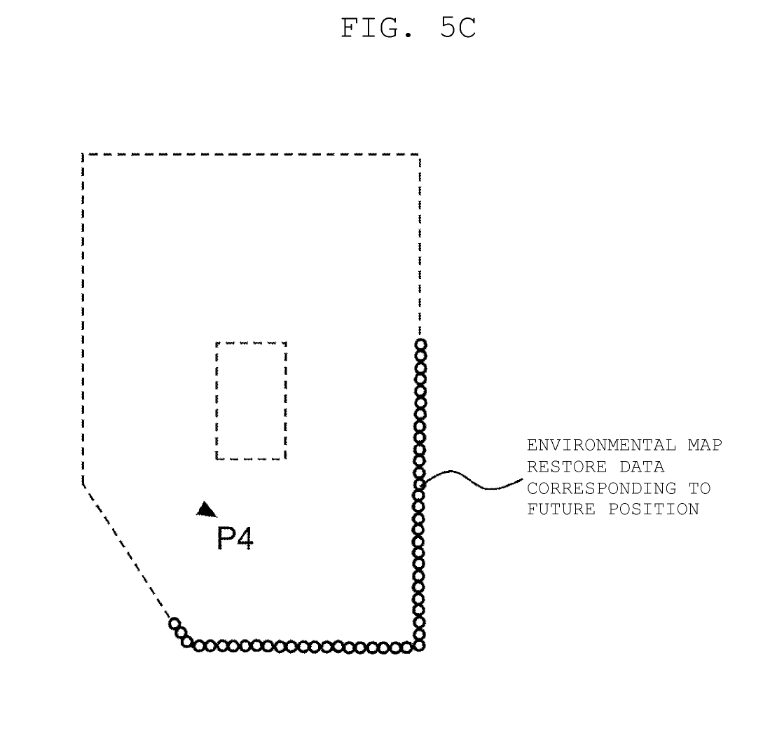

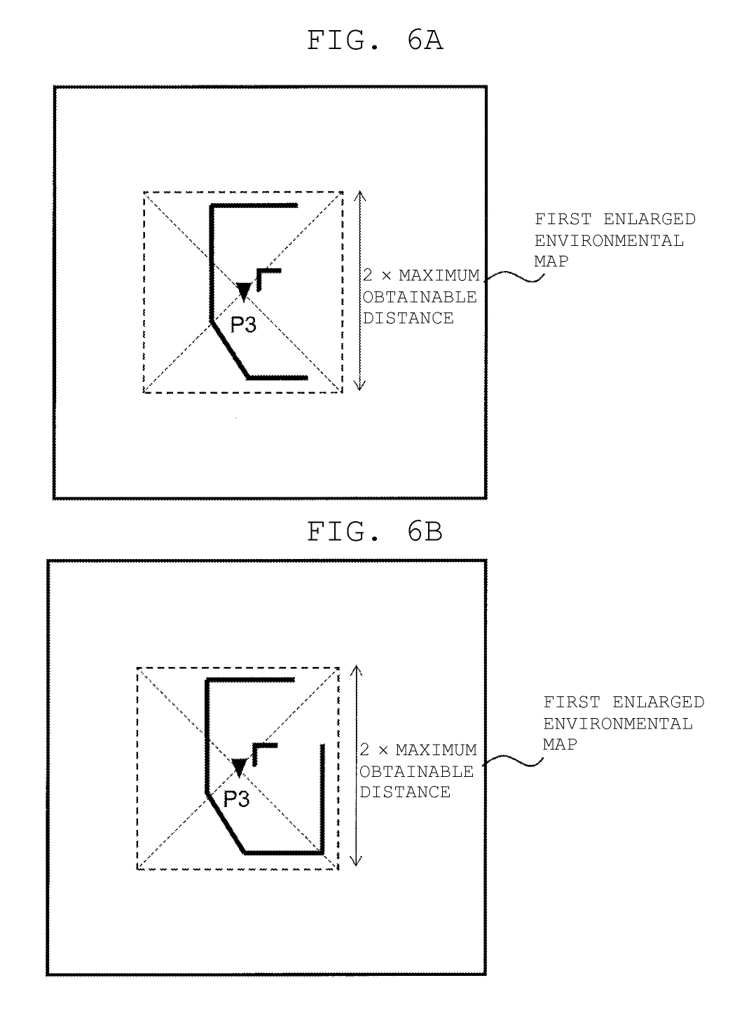

At this time, when the instruction traveling mode is executed in the mobile body 100, the first enlarged environmental map indicated by a solid line in FIG. 6A is created. On the other hand, when the reproduction traveling mode is executed in the mobile body 100, the first enlarged environmental map indicated by a solid line in FIG. 6B is created.

FIG. 6A is a diagram illustrating one example of the first enlarged environmental map to be created when the instruction traveling mode is executed. FIG. 6B is a diagram illustrating one example of the first enlarged environmental map to be created when the reproduction traveling mode is executed.

After the first enlarged environmental map is created, the map creating unit 531 extracts a quadrate region where one side has a length twice as long as the maximum obtainable distance of the forward laser range sensor 31 and whose intersection of diagonal lines is the position P3 (in FIG. 6A and FIG. 6B, a region inside the quadrate indicated by a dotted line) from the first enlarged environmental map, so as to create a second enlarged environmental map (step S1002).

A region outside the quadrate region where one side has the length twice as long as the maximum obtainable distance of the forward laser range sensor 31 and whose intersection of the diagonal lines is the position P3 is a region spaced away from the position P3 by the maximum obtainable distance or more, and a region outside the measurement range of the obstacle information obtaining unit 3 (hereinafter, a measurement range outer region). That is, the position information about the obstacle present in the measurement range outer region cannot be obtained by the obstacle information obtaining unit 3.

When the first enlarged environmental map is used as the environmental map, the environmental map becomes wide (for example, one side is about six times as long as the maximum obtainable distance). For this reason, an annular route problem easily arises in the environmental map. Therefore, when a region corresponding to the measurement range outer region is deleted as the non-information region (a region where the position information about the obstacle cannot be obtained) from the first enlarged environmental map, the region where the position information about the obstacle cannot be obtained because the region is out of the measurement range can be excluded from the environmental map. As a result, an occurrence probability of the annular route problem on the environmental map is able to be reduced.

When the obstacle information obtaining unit 3 (in this preferred embodiment, the forward laser range sensor 31) has a measurement range wider than the moving region S as illustrated in FIG. 4, it executes step S1002 to create the second enlarged environmental map. Also when the second enlarged environmental map is used as the environmental map, the annular route problem occasionally arises. This is because when the obstacle information obtaining unit 3 has the measurement range wider than the moving region S, the position information about the obstacle included in the second enlarged environmental map created in the past remains on the second enlarged environmental map created on the current position (the position P3).

Further, the position information about the obstacle that remains on the second enlarged environmental map created on the position P3 occasionally includes position information about obstacle that could be obtained at initial movement of the mobile body 100 but becomes unable to be obtained as the mobile body 100 further moves.

The annular route problem arises particularly when, for example, as stated above, when after the position information about an obstacle around a movement start position is obtained, the mobile body 100 moves and thus the position information about the obstacle around the movement start position becomes unable to be obtained and the mobile body 100 returns near the movement start position to create the environmental map, the created environmental map includes the position information about the obstacle obtained at the time of starting the movement.

In this preferred embodiment, therefore, after the second enlarged environmental map is created, the obstacle information obtaining unit 3 specifies the region where the position information about the obstacle became unable to be obtained, specifies a region on the second enlarged environmental map corresponding to the former region (the non-information region), and deletes the position information about the obstacle present on the non-information region from the second enlarged environmental map. In other words, out of the position information about the obstacle included in the second enlarged environmental map, the position information about the obstacle that became unable to be obtained by the obstacle information obtaining unit 3 is deleted, so that occurrence of the annular route problem in the environmental map is significantly reduced or prevented.

In this preferred embodiment, specifically as follows, the position information about the obstacle present in the non-information region is deleted from the second enlarged environmental map.

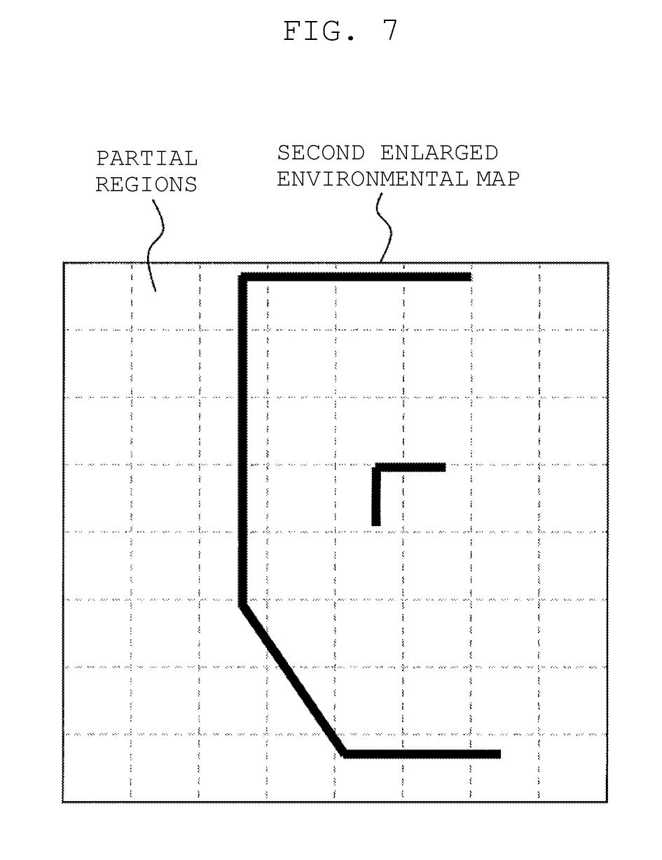

After the second enlarged environmental map is created, the map creating unit 531 first divides the second enlarged environmental map into a plurality of partial regions (step S1003). For example, as illustrated in FIG. 7, the second enlarged environmental map is divided into partial regions of 8×8. FIG. 7 is a diagram schematically illustrating one example where the second enlarged environmental map is divided. A number of divisions of the second enlarged environmental map is not limited to 8×8 (=64 regions), and the map can be divided into any number of regions.

After the second enlarged environmental map is divided into the plurality of partial regions, the map creating unit 531 counts the position information about the obstacle present on the respective partial regions (step S1004). Specifically, when the mobile body 100 executes the instruction traveling mode, the map creating unit 531 plots the position information about the obstacle obtained on the position P3 on the second enlarged environmental map, so as to count the position information about the obstacle included in the respective partial regions.

On the other hand, when the mobile body 100 is executing the reproduction traveling mode, the map creating unit 531 counts the position information about the obstacle included in the respective partial regions. This position information includes the position information about the obstacle of the environmental map restore data corresponding to the future position P4 at which the mobile body 100 plans to arrive from the position P3 as well as the position information about the obstacle obtained on the position P3.

That is, when the mobile body 100 is executing the reproduction traveling mode, the map creating unit 531 plots the position information about the obstacle obtained on the position P3 and the position information about the obstacle included in the environmental map restore data corresponding to the position P4 on the second enlarged environmental map, so as to count the position information about the obstacle included in the respective partial regions.

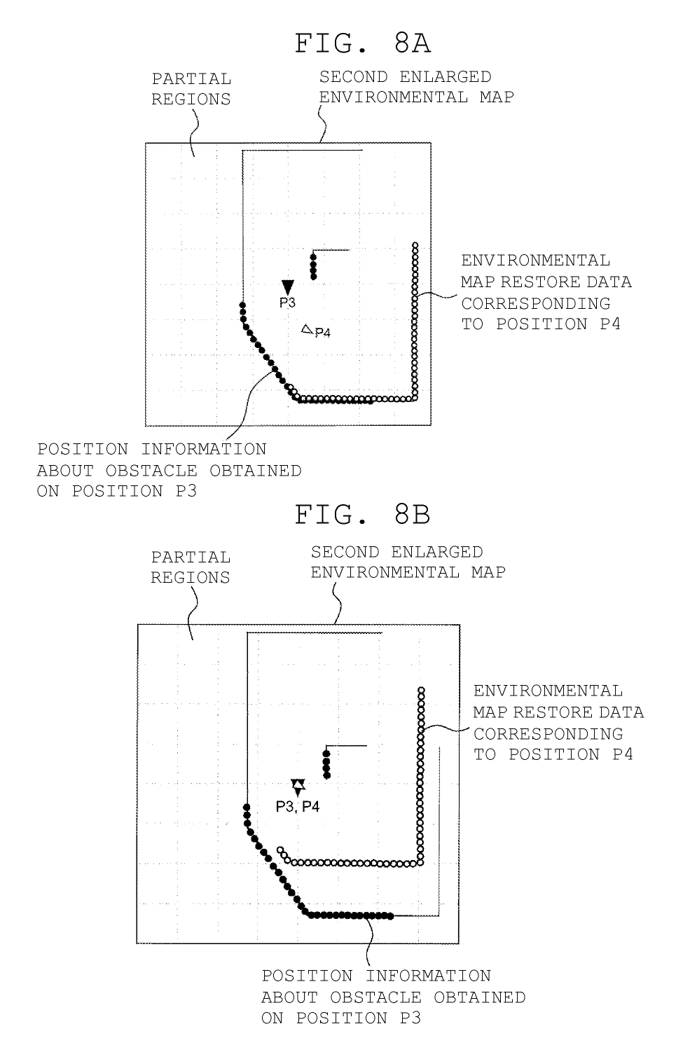

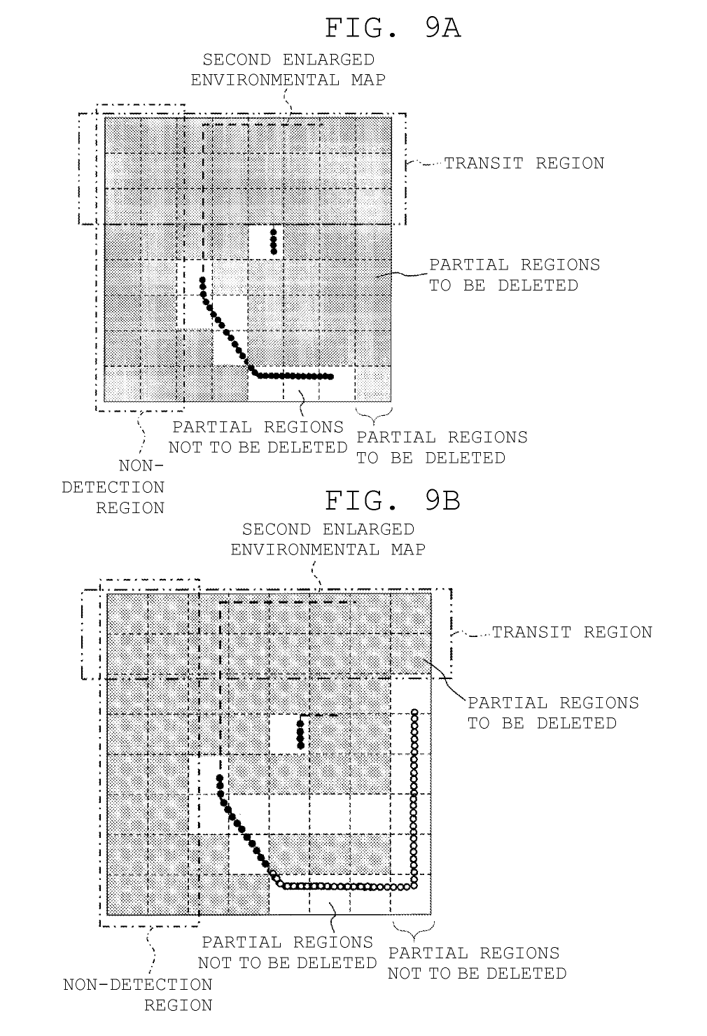

When the position information about the obstacle included in the respective partial regions that includes the environmental map restore data corresponding to the future position P4 as well as the position information about the obstacle obtained on the position P3 as the position information about the obstacle is counted, the map creating unit 531 plots, as illustrated in FIG. 8A, the position information about the obstacle of the environmental map restore data on the second enlarged environmental map so that a relative position relationship between the current estimated position P3 and the future position P4 is held. That is, the environmental map restore data corresponding to the future position P4 read from the storage unit 57 is disposed on a position of the second enlarged environmental map corresponding to the future position P4.

FIG. 8A is a diagram illustrating one example of a state in which the position information about the obstacle obtained on the current estimated position and the environmental map restore data corresponding to the future position are plotted on the second enlarged environmental map.

In another manner, as illustrated in FIG. 8B, the environmental map restore data corresponding to the future position P4 may be disposed on the current position P3. In this case, a coordinate moving process does not have to be executed on the environmental map restore data. A selection can be suitably made whether the environmental map restore data corresponding to the read future position P4 is disposed on the current position P3 or on the future position P4 in consideration of a processing speed and the like.

FIG. 8B is a diagram illustrating another example of a state in which the position information about the obstacle obtained on the current estimated position and the environmental map restore data corresponding to the future position are plotted on the second enlarged environmental map.

After the number of pieces of the position information about the obstacle included in the partial regions is counted, the map creating unit 531 determines whether the number of pieces of the position information about the obstacle included in the respective partial regions is a first number or more (step S1005).

When the number of the pieces of the position information about the obstacle included in one partial region is the first number or more (“Yes” in step S1005), this one partial region is a partial region not to be deleted but to remain. That is, this one partial region is determined as not being a partial region to be deleted (step S1006).

On the other hand, when the number of the pieces of the position information about the obstacle included in the one partial region is less than the first number (“No” in step S1005), the map creating unit 531 determines whether a state where the number of pieces of the position information about the obstacle included in this one partial region is less than the first number continues for a first time or more (step S1007).

When the determination is made that the state where the number of pieces of the position information about the obstacle included in one partial region is less than the first number continues for the first time or more (“Yes” in step S1007), the map creating unit 531 determines that the one partial region is the partial region to be deleted (step S1008).

On the other hand, when it is determined that the state where the number of pieces of the position information about the obstacle in this one partial region is less than the first number continues for a time shorter than the first time (“No” in step S1007), a lower number of pieces of the position information about the obstacle is temporarily obtained on the one partial region because of a noise or a dynamic obstacle, or a detection signal is temporarily blocked by a dynamic obstacle and thus the number of pieces of the position information about the obstacle is likely to be reduced. For this reason, the map creating unit 531 determines that the one partial region is not the partial region to be deleted (step S1006).

When the state where the number of pieces of the position information about the obstacle included in the one partial region is less than the first number continues for the first time or more, the partial region is determined as the partial region to be deleted. As a result, a partial region to be originally deleted is prevented from being determined as not being the partial region to be deleted by mistake when a small number of pieces of the position information about the obstacle (less than the first number) is obtained in a short time such as a case where a noise generated in the obstacle information obtaining unit 3 or a moving object present in a position far from the mobile body 100 (for example, a walker present in the position sufficiently far from the mobile body 100) temporarily comes insight of the obstacle information obtaining unit 3.

Further, when the state where the number of pieces of the position information about the obstacle included in one partial region is less than the first number continues for the first time or more, this partial region is determined as the partial region to be deleted. As a result, a partial region, which does not temporarily include the position information about the obstacle, is prevented from being the partial region to be deleted by mistake when the position information about the obstacle cannot be temporarily obtained because the forward laser range sensor 31 and the backward laser range sensor 33 come into blind angles due to their attached position to the mobile body 100.

That is, the partial region to be deleted is determined as the partial region that continuously includes less than the first number of pieces of the position information about the obstacle for the first time or more. As a result, a region that can be deleted from the second enlarged environmental map is suitably selected so as to be capable of being deleted from the second enlarged environmental map.

The first number is able to be determined based on a performance of the obstacle information obtaining unit 3 (for example, an occurrence frequency of a noise) and a size of a partial region. Further, the first time is able to be determined based on a possibility that an obstacle is temporarily blocked by an object (a walker or the like) in front thereof and the moving speed of the mobile body 100.

After a partial region is determined as the partial region not to be deleted in step S1006 or a partial region is determined as the partial region to be deleted in step S1008, the map creating unit 531 checks whether the number of pieces of the position information about the obstacle is counted on all the partial regions (step S1009).

When the number of pieces of the position information about the obstacle is not counted on all the partial regions (“No” in step S1009), the process for creating the environmental map returns to step S1004, and steps S1004 to S1008 are repeated until the number of pieces of the position information about the obstacle is counted on all the partial regions.

On the other hand, when the number of pieces of the position information about the obstacle is counted on all the partial regions (“Yes” in step S1009), the map creating unit 531 checks whether the second number or more of the partial regions to be deleted are continuously present (step S1010).

In this preferred embodiment, the map creating unit 531 checks whether partial regions to be deleted whose number is the same as the number of divisions in columns (in the drawing, a vertical direction) are continuously present in columns and/or partial regions to be deleted whose number is the same as the number of divisions in rows (in the drawing, a lateral direction) are continuously present in rows.

That is, in this preferred embodiment, the second number is determined as the number of divisions in columns and/or the number of divisions in rows.

The number of divisions in columns is the number of divisions in columns on the second enlarged environmental map, and it preferably is 8, for example, in this preferred embodiment. On the other hand, the number of divisions in rows is the number of divisions in rows on the second enlarged environmental map, and it preferably is 8, for example, in this preferred embodiment.

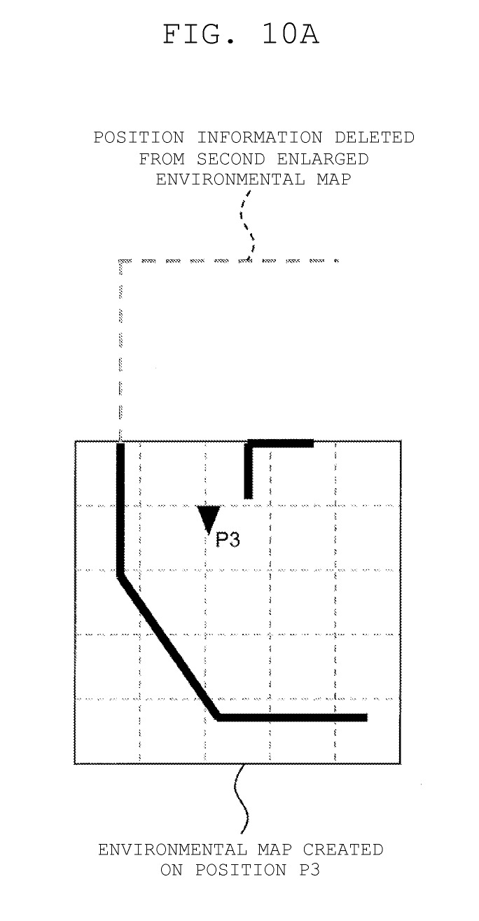

When the number of pieces of the position information about the obstacle is counted on all the partial regions and the determination is made whether the respective partial regions are the partial regions to be deleted, colored partial regions in FIG. 9A are the partial regions to be deleted while the mobile body 100 is executing the instruction traveling mode. FIG. 9A is a diagram illustrating one example of the partial regions to be deleted when the position information about the obstacle is counted during the execution of the instruction traveling mode.

In FIG. 9A, the partial regions to be deleted present on three lines from a top on the second enlarged environmental map are continuously present in rows by the number of divisions in rows (for example, 8 regions). Further, the partial regions to be deleted present on two rows from a left on the second enlarged environmental map and the partial regions to be deleted present in one row on a right end are continuously present in columns by the number of divisions in columns (for example, 8 regions).

On the other hand, while the mobile body 100 is executing the reproduction traveling mode, the colored partial regions in FIG. 9B become the partial regions to be deleted. FIG. 9B is a diagram illustrating one example of the partial regions to be deleted when the position information about the obstacle is counted during the execution of the reproduction traveling mode.

FIG. 9B illustrates a determination result of the partial regions to be deleted when the environmental map restore data corresponding to the future position P4 read as illustrated in FIG. 8A is disposed on the future position P4 on the second enlarged environmental map as an example.

In FIG. 9B, the partial regions to be deleted present on two lines from the top on the second enlarged environmental map are continuously present in rows by the number of divisions in rows (8 regions). Further, the partial regions to be deleted present on two lines from the left on the second enlarged environmental map are continuously present in columns by the number of divisions in columns (8 regions).

When the determination is made that the partial regions to be deleted are not continuously present in columns by the number of divisions in columns and are not continuously present in rows by the number of divisions in rows (“No” in step S1010), the map creating unit 531 does not delete the partial regions to be deleted (step S1011) and ends the process for creating the environmental map.

On the other hand, when the determination is made that the partial regions to be deleted are continuously present in columns by the number of divisions in columns and/or are continuously present in rows by the number of divisions in rows (“Yes” in step S1010), the map creating unit 531 deletes the partial regions to be deleted that are continuously present in columns by the number of divisions in columns and/or the partial regions to be deleted that are continuously present in rows by the number of divisions in rows as the non-information regions where the obstacle information obtaining unit 3 cannot obtain the position information about the obstacle (step S1012). Thereafter, the process for creating the environmental map is ended.

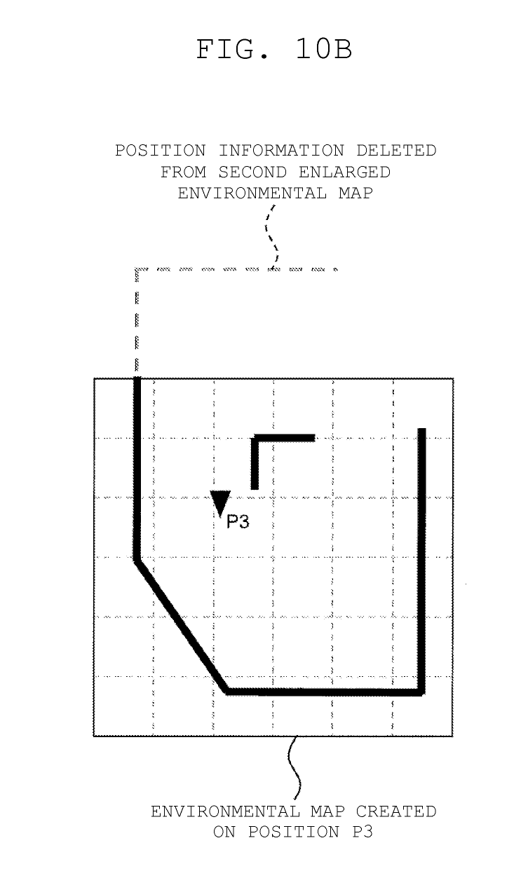

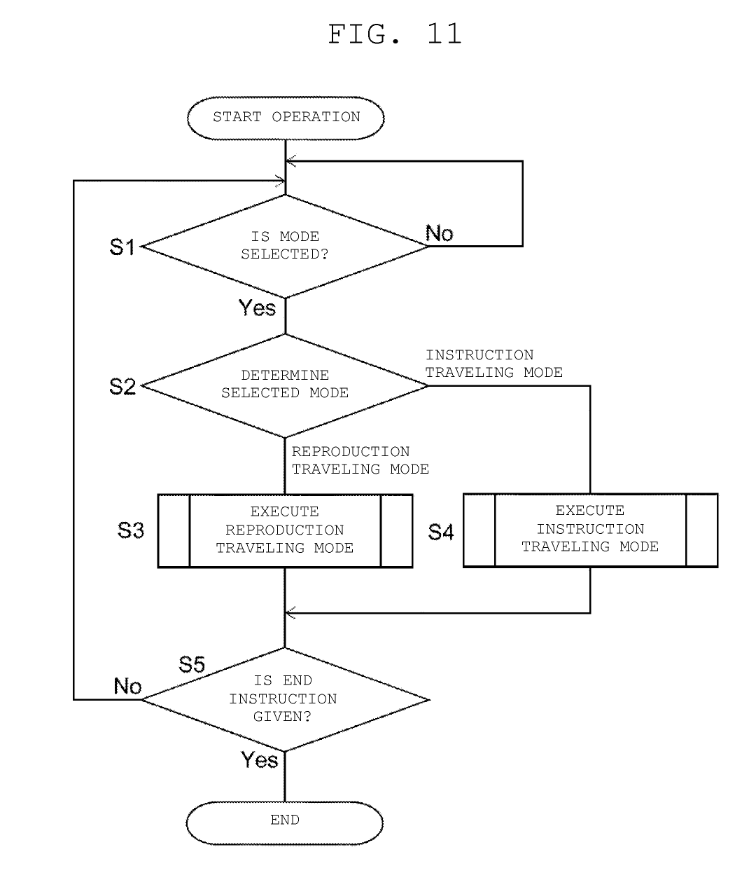

For example, when the partial regions to be deleted are determined as illustrated in FIG. 9A at the time of the execution of the instruction traveling mode, an environmental map indicated by a solid line in FIG. 10A is created on the position P3. FIG. 10A is a diagram illustrating one example of the environmental map to be created on a current position during the execution of the instruction traveling mode.

On the other hand, when the partial regions to be deleted are determined as illustrated in FIG. 9B at the time of executing the reproduction traveling mode, an environmental map indicated by a solid line in FIG. 10B is created on the position P3. FIG. 10B is a diagram illustrating one example of the environmental map to be created on a current position at the time of executing the reproduction traveling mode.

The two environmental maps illustrated in FIG. 10A and FIG. 10B have two common points and one different point. The first common point is that both the environmental map illustrated in FIG. 10A and the environmental map illustrated in FIG. 10B are created by deleting the position information about the obstacle present on an upper portion of the second enlarged environmental map (in FIG. 9A and FIG. 9B, portions surrounded by alternate long and two short dashes line).

The regions on the second enlarged environmental map surrounded by the alternate long and two short dashes line in FIG. 9A and FIG. 9B are regions through which the mobile body 100 passes from the position P2 to arrive at the position P3, and are regions where the obstacle information obtaining unit 3 cannot obtain the position information about the obstacle present on the regions.

The regions where the mobile body 100 passes until the arrival at the position P3 and the obstacle information obtaining unit 3 cannot obtain the position information about the obstacle present on the regions are referred to as “transit regions”.

Steps S1003 to S1012 are executed so that the transit regions are deleted as the non-information regions from the second enlarged environmental map. As a result, the regions where the mobile body 100 already passes and the obstacle information obtaining unit 3 cannot obtain the position information about the obstacle can be excluded from the environmental map. As a result, the occurrence of the annular route problem on the environmental map is prevented.

The second common point is that both the environmental maps illustrated in FIG. 10A and the environmental map illustrated in FIG. 10B are created by deleting partial regions on two columns at the left end on the sheet of the second enlarged environmental map (in FIG. 9A and FIG. 9B, the regions surrounded by alternate long and short dash lines).

That is, both the above two environmental maps are created by deleting, out of the regions included in the second enlarged environmental map, regions spaced away from the position P3 (the estimated position) by a distance up to the position information about the obstacle actually obtained on the position P3 or more.

Like the regions surrounded by the alternate long and short dash lines illustrated in FIG. 9A and FIG. 9B, the regions spaced away from the position P3 (the estimated position) by the distance up to the position information about the obstacle actually obtained on the position P3 or more are referred to as “non-detection regions”.

When steps S1003 to S1012 are executed and the non-detection regions are deleted as the non-information regions from the second enlarged environmental map, the regions in a thickness direction of an obstacle where the obstacle information obtaining unit 3 cannot obtain the position information about the obstacle are able to be excluded from the environmental map.

On the other hand, a different point between the two environmental maps illustrated in FIG. 10A and FIG. 10B is that partial regions on one column at the right end of the sheet of the second enlarged environmental map are deleted on the environmental map illustrated in FIG. 10A, but the partial regions on that one column are not deleted on the environmental map illustrated in FIG. 10B.

The partial regions on the one column at the right end of the sheet include, as illustrated in FIG. 9B, the position information about the obstacle included in the environmental map restore data corresponding to the future position P4.

At the time of executing the reproduction traveling mode for creating the environmental map using the environmental map restore data on the future position, when a determination is made by using only the position information about the obstacle obtained on the position P3 whether the partial regions are the partial regions to be deleted as illustrated in FIG. 9A, the partial regions being included in the environmental map restore data on the future position are also deleted.

Therefore, when the environmental map is created by using the environmental map restore data corresponding to the future position, the position information about the obstacle included in the partial regions as well as the position information about the obstacle obtained on the position P3 and also the position information about the obstacle included in the environmental map restore data corresponding to the future position P4 is counted so that the determination is made whether the partial regions are the partial region to be deleted. In such a manner, the position information about the obstacle included in the environmental map restore data corresponding to the future position P4 is prevented from being deleted from the environmental map by mistake.

Further, when the partial regions to be deleted continue in columns by the number of divisions in columns and/or when the partial regions to be deleted continue in rows by the number of divisions in rows, the partial regions to be deleted are deleted so that the partial regions to be deleted are deleted efficiently.

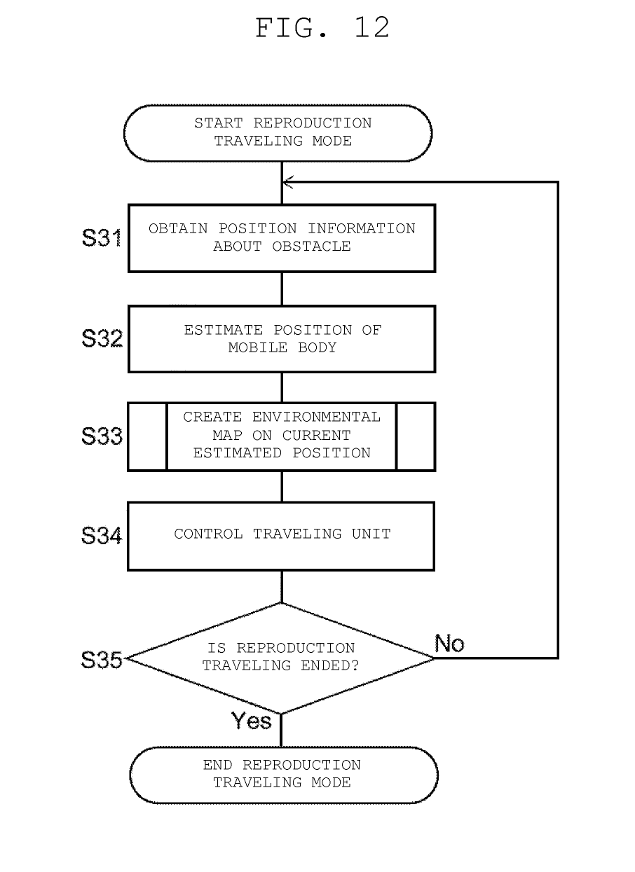

The specific operation of the mobile body 100 is described below. The summary of the operation of the mobile body 100 is described first with reference to FIG. 11. FIG. 11 is a flowchart illustrating the summary of the operation of the mobile body.

When the operation of the mobile body 100 starts, the controller 5 determines whether an operator selects the mode (step S1). Specifically, for example, when the instruction input is accepted through the operation unit 7 operated by the operator or when an instruction input signal is received from a remote controller, the determination is made that the mode is selected.

When the determination is made that the mode is not selected by the operator (“No” in step S1), the operating process of the mobile body 100 returns to step S1, and waits until the operator selects the mode.

On the other hand, when the determination is made that the operator selects the mode (“Yes” in step S1), the controller 5 determines whether the selected mode is the instruction traveling mode or the reproduction traveling mode (step S2).

When the selected mode is determined as the reproduction traveling mode (“the reproduction traveling mode” in step S2), the controller 5 executes the reproduction traveling mode (step S3).

On the other hand, when the selected mode is determined as the instruction traveling mode (“the instruction traveling mode” in step S2), the controller 5 executes the instruction traveling mode (step S4).

While or after the reproduction traveling mode or the instruction traveling mode is executed, the controller 5 determines whether the operation of the mobile body 100 is to be ended (step S5).

Specifically, when an instruction for ending the process is input by the operator through the operation unit 7, when the instruction input signal for ending the process is received through the remote controller, or when a determination is made that the traveling schedule created in the instruction traveling mode is ended, the controller 5 determines that the operation of the mobile body 100 is to be ended.

When the determination is made that the operation of the mobile body 100 is to be ended (“Yes” in step S5), the operation of the mobile body 100 is ended. On the other hand, when the operation of the mobile body 100 is to be continued (“No” in step S5), the operating process of the mobile body 100 returns to step S1, and the operation of the mobile body 100 is continued.

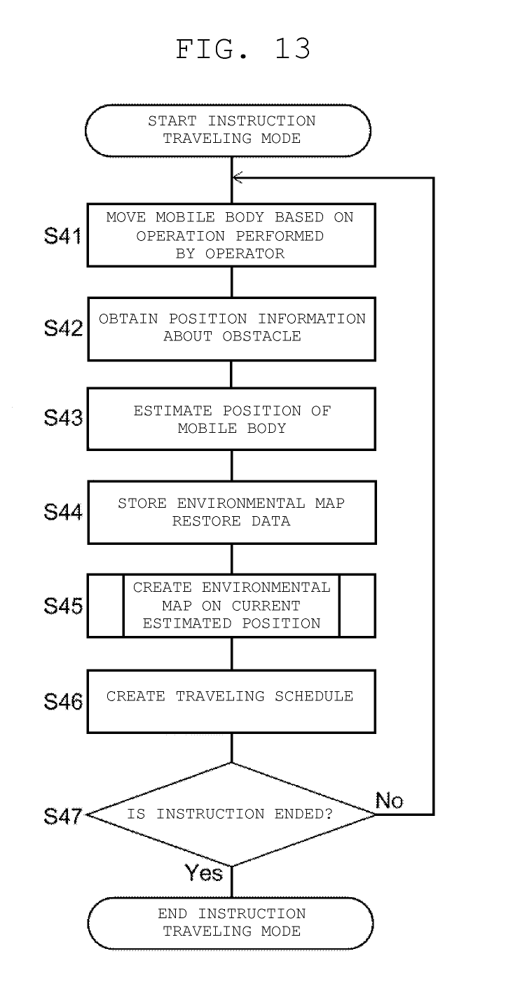

The operation of the mobile body 100 during the execution of step S3 (namely, during the execution of the reproduction traveling mode) is described below with reference to FIG. 12. FIG. 12 is a flowchart illustrating an operation of the mobile body during the execution of the reproduction traveling mode.

When the mobile body 100 starts the reproduction traveling mode, position information about an obstacle present around the mobile body 100 is obtained (step S31). Specifically, the forward laser range sensor 31 and the backward laser range sensor 33 of the obstacle information obtaining unit 3 emit laser beams and receive reflection light received from an obstacle.

Thereafter, the obstacle information converter 55 converts detection signals output from the obstacle information obtaining unit into position information about the obstacles (for example, coordinate values on a predetermined coordinate) based on the received reflection light. The position information about the obstacle coordinate-converted by the obstacle information converter 55 is determined as the local map obtained on a current position.

After the position information about the obstacle on the current position is obtained, the self position estimating unit 533 estimates the current position of the mobile body 100 (step S32).

Specifically, the self-position estimating unit 533 adds an amount of a movement made by the traveling unit 1 between the past time and a current time to an estimated position at a past time.

The self-position estimating unit 533, then, sets a plurality of “temporary estimated positions” spaced away from a position calculated by adding the amount of the movement made by the traveling unit 1 by a predetermined distance, and disposes the local map on the temporary estimated positions. Thereafter, the self-position estimating unit 533 matches the environmental map that is created at a previous time and is stored in the storage unit 57 with the plurality of local maps disposed on the temporary estimated positions. The temporary estimated position when the local map disposed thereon matches with the environmental map created at the previous time the most is estimated as a current position of the mobile body 100 in the moving region S.

After the current estimated position of the mobile body 100 is estimated, the map creating unit 531 executes steps S1001 to S1012 described above with a next target arrival point shown in the traveling schedule being set as the future position, so as to create an environmental map for estimating a next self-position (on the current estimated position) and store the created map in the storage unit 57 (step S33).

After the environmental map on the current estimated position is created, the traveling controller 59 calculates control amounts of the motors 11a and 11b for a movement from the current estimated position to the next target arrival point based on comparison between the current estimated position obtained from the SLAM processor 53 and the next target arrival point obtained from the traveling schedule showing a traveling route where the reproduction traveling is currently carried out. The traveling controller 59, then, outputs the calculated amounts to the motor drive units 15a and 15b, respectively (step S34).

When the motor drive units 15a and 15b receive the control amounts of the motors 11a and 11b, the motor drive units 15a and 15b calculate drive signals to drive the motors 11a and 11b, respectively, based on the received control amounts so as to output the drive signals to the motors 11a and 11b, respectively. As a result, the mobile body 100 travels from the current estimated position toward the next target arrival point.

After controlling the motors 11a and 11b of the traveling unit 1, the controllers determines whether the reproduction traveling mode is ended (step S35). For example, when a determination is made that the mobile body 100 passes through all the target arrival points shown in the traveling schedule, the controller 5 determines that the reproduction traveling mode is ended. In another manner, a stop button of the operation unit 7, for example, is pressed, so that the reproduction traveling mode is ended in midstream.

When the determination is made that the reproduction traveling mode is to be ended (“Yes” in step S35), the controller 5 stops the control of the traveling unit 1 so as to end the reproduction traveling mode.

On the other hand, when the determination is made that the reproduction traveling mode is to be continued (“No” in step S35), the executing process of the reproduction traveling mode returns to step S31 so as to repeat steps S31 to S34 until the determination is made that the reproduction traveling mode is to be ended.

When steps S31 to S35 are executed so that the reproduction traveling mode is executed in the mobile body 100, the mobile body 100 is able to autonomously move while the predetermined traveling schedule stored in the storage unit 57 is being reproduced.

The operation of the mobile body 100 in step S4 during the execution of the instruction traveling mode is described below with reference to FIG. 13. FIG. 13 is a flowchart illustrating the operation of the mobile body during the execution of the instruction traveling mode. The instruction traveling mode is executed in order to obtain the environmental map restore data or the traveling schedule to be used at the time of executing the reproduction traveling mode.

When the execution of the instruction traveling mode is started in the mobile body 100, the traveling controller 59 first creates control amounts of the motors 11a and 11b of the traveling unit 1 based on an operating amount of an operation in the operation unit 7 performed by the operator, and outputs the control amounts to the motors 11a and 11b, respectively (step S41).

For example, when an instruction input relating to a traveling speed and a steering input by an operation of a throttle of the operation unit 7 performed by the operator is accepted, and the traveling on the traveling route is controlled. The instruction input from the operator may be performed using a system that receives an instruction input signal through a radio from a remote controller.

The execution of step S41 makes the mobile body 100 move based on the operation performed by the operator.

After the traveling unit 1 is controlled based on the operation performed by the operator, the obstacle information obtaining unit 3 obtains position information about an obstacle present around the mobile body 100 similarly to the description about step S31 at the time of executing the reproduction traveling mode (step S42).

After the position information about the obstacle is obtained, the self-position estimating unit 533 estimates a current estimated position of the mobile body 100 similarly to the description about step S32 at the time of executing the reproduction traveling mode (step S43).

After the current position of the mobile body 100 is estimated, the SLAM processor 53 relates the position information about the obstacle (the local map) obtained in step S42 to the current estimated position of the mobile body 100, and stores the position information about the obstacle related to the estimated position as the environmental map restore data in the storage unit 57 (step S44).

The position information about the obstacle obtained in step S42 is related to the estimated position so as to be set as the environmental map restore data so that the map creating unit 531 is able to refer to the environmental map restore data to be used to create the first enlarged environmental map at the time of executing the reproduction traveling mode.

When step S44 is executed, the SLAM processor 53 stores the position information about the obstacle obtained on a predetermined position of the moving region S as the environmental map restore data in the storage unit 57.

After the environmental map restore data is stored in the storage unit 57, the map creating unit 531 executes steps S1001 to S1012, and creates the environmental map on the current estimated position so as to store the environmental map in the storage unit (step S45).

After the environmental map is created, the instruction data creating unit 51 creates the traveling schedule so as to store the traveling schedule in the storage unit 57 (step S46).

Specifically, the instruction data creating unit 51 stores the estimated position at a current time and a posture indicating the traveling direction of the mobile body 100 in the storage unit 57 so as to create the traveling schedule. The instruction data creating unit 51 may store also the current time in the traveling schedule.

The estimated position and the posture of the mobile body 100 are obtained at respective predetermined time intervals (a time schedule) so as to be stored in the storage unit 57. As a result, the positions at which the mobile body 100 arrives at the respective predetermined times through an operation performed by the operator and the postures of the mobile body 100 at the respective predetermined times are able to be stored as the traveling schedule in the storage unit 57.

After the traveling schedule is created, the controller 5 determines whether the execution of the instruction traveling mode is to be ended (step S47).

Specifically, for example, when the instruction for ending the process is input by the operator through the operation unit 7 or when the instruction input signal to end the process is received through the remote controller, the controller 5 determines that the execution of the instruction traveling mode is to be ended. When the operation of the operation unit 7 is not performed for a predetermined time or more during the execution of the instruction traveling mode, the determination may be made that the execution of the instruction traveling mode is to be ended.

When the determination is made that the execution of the instruction traveling mode is to be ended (“Yes” in step S47), the controller 5 ends the instruction traveling mode.

On the other hand, when the determination is made that the execution of the instruction traveling mode is to be continued (“No” in step S47), the executing process of the instruction traveling mode returns to step S41, and steps S41 to S46 are repeated until the determination is made that the execution of the instruction traveling mode is to be ended.

When steps S41 to S47 are executed so that the instruction traveling mode is executed, the traveling route where the mobile body 100 moves based on the operation performed by the operator is able to be stored as the traveling schedule in the storage unit 57. Further, the position information about the obstacle that is obtained when the mobile body 100 is moved based on the operation performed by the operator is stored as the environmental map restore data in the storage unit 57, so that the position information about the obstacle obtained on a predetermined position by the obstacle information obtaining unit 3 can be stored as the environmental map restore data in the storage unit 57.

### Other Preferred Embodiments

Preferred embodiments of the present invention are described above, but the present invention is not limited to the above preferred embodiments, and various modifications can be made within a range that does not deviate from the subject matter of the present invention. In particular, the plurality of preferred embodiments and alternative preferred embodiments described in this specification can be arbitrarily combined as needed.

Further, the process at the respective steps in the flowchart described above may be changed within the scope of the present invention. Further, an order of the steps described in the flowchart may be changed within the scope of the present invention.

In the first preferred embodiment, the second number for determining the partial region to be deleted preferably is identical to the number of divisions in rows and/or the number of divisions in columns (for example, 8 in the first preferred embodiment) in order to efficiently delete the partial regions to be deleted. That is, in the first preferred embodiment, when all partial regions in rows on the second enlarged environmental map are the partial regions to be deleted and/or all partial regions in columns on the second enlarged environmental map are the partial regions to be deleted, the partial regions to be deleted are deleted.

However, not limited to this, the second number may be smaller than the number of divisions in rows and/or the number of divisions in columns. For example, when the second number is set to 1, all the partial regions that are determined as the partial regions to be deleted can be deleted. In another manner, the second number may be larger than 1 and may be smaller than the number of divisions in rows and/or the number of divisions in columns. In this case, when the partial regions to be deleted are continuously present in rows and/or in columns by the second number or more, the partial regions to be deleted can be deleted.

In the first preferred embodiment, the regions to be used to extract the second enlarged environmental map from the first enlarged environmental map preferably has a quadrate whose one side has a length twice as long as a maximum obtainable distance of a forward laser range sensor 31 and whose intersection of diagonal lines is a position P3. However, not limited to this, the above regions may be defined in consideration of the measurement range (the maximum obtainable distance) of a backward laser range sensor 33.

For example, the regions to be used to extract the second enlarged environmental map from the first enlarged environmental map may have a rectangular or substantially rectangular shape whose side in a widthwise direction of a mobile body 100 has a length twice as long as the maximum obtainable distance of the forward laser range sensor 31 and whose side in an advancing direction of the mobile body 100 has a length that is a sum of the maximum obtainable distance of the forward laser range sensor 31 and the maximum obtainable distance of the backward laser range sensor 33.

In this case, the position P3 is not set at an intersection of diagonal lines of the rectangle, but for example, the position P3 may be set on a position where a distance between a back side and a long side of the mobile body 100 (a side whose length is twice as long as the maximum obtainable distance of the forward laser range sensor 31) becomes the maximum obtainable distance of the backward laser range sensor 33.

When the second enlarged environmental map is extracted from the first enlarged environmental map with the above rectangular shape, a region where the backward laser range sensor 33 cannot obtain position information about an obstacle is able to be excluded from the second enlarged environmental map.

Preferred embodiments of the present invention may be applied widely to a mobile body that travels in a moving region during the estimation of the position in the moving region.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A mobile body traveling in a moving region during estimation of a position in the moving region, the mobile body comprising:
an obstacle information obtaining unit that obtains position information about an obstacle present around the mobile body;
a storage unit that stores environmental map restore data as the position information about the obstacle obtained on a predetermined position of the moving region in advance and an environmental map created at a previous time;
a self-position estimating unit that estimates a current position as an estimated position based on a comparison between the environmental map created at the previous time and the position information about the obstacle obtained by the obstacle information obtaining unit; and
a map creating unit that creates an enlarged environmental map using the environmental map restore data and/or the position information about the obstacle obtained on the estimated position and the environmental map created at the previous time, and deleting, out of regions included in the enlarged environmental map, a region corresponding to a non-information region where the obstacle information obtaining unit cannot obtain the position information about the obstacle from the enlarged environmental map, so as to create an environmental map on the estimated position.

2. The mobile body according to claim 1, wherein the map creating unit deletes, out of the regions included in the enlarged environmental map, a region corresponding to a transit region where the mobile body passes until arrival at the estimated position as the non-information region from the enlarged environmental map.

3. The mobile body according to claim 1, wherein the map creating unit deletes, out of the regions included in the enlarged environmental map, a region corresponding to a measurement range outer region as the non-information region from the enlarged environmental map, the measurement range outer region being a region spaced away from the estimated position by a maximum obtainable distance, in which the obstacle information obtaining unit obtains the position information about the obstacle, or more.

4. The mobile body according to claim 1, wherein the map creating unit deletes, out of the regions included in the enlarged environmental map, a region corresponding to a non-detection region as the non-information region from the enlarged environmental map, the non-detection region being a region spaced away from the estimated position by a distance up to the position information about the obstacle actually obtained by the obstacle information obtaining unit or more.

5. The mobile body according to claim 1, wherein the map creating unit divides the enlarged environmental map into a predetermined number of partial regions, and deletes a partial region to be deleted as the non-information region from the enlarged environmental map, the partial region to be deleted being a partial region in which a state where less than a first number of pieces of the position information about the obstacle are included continues for a first time or more.

6. The mobile body according to claim 5, wherein when a second number or more of the partial regions to be deleted are continuously arranged in columns or in rows, the map creating unit deletes a region defined by the continuously arranged second number or more of the partial regions to be deleted as the non-information region from the enlarged environmental map.

7. The mobile body according to claim 6, wherein the second number is identical to a number of divisions in columns on the enlarged environmental map and/or a number of divisions in rows on the enlarged environmental map.

8. The mobile body according to claim 5, wherein when the enlarged environmental map is created by using the environmental map restore data corresponding to a future position to which the mobile body plans to arrive by moving from a current estimated position, the map creating unit counts the position information about the obstacle included in the partial regions and the position information about the obstacle on the current estimated position and the position information about the obstacle of the environmental map restore data corresponding to the future position.
